(19) United States
(12) Patent Application Publication
(10) Pub. No.: US 2004/0158931 A1
(43) Pub. Date: Aug. 19, 2004

(54) Sole survivor ( A six in one multiple use tool )

(76) Inventors: Michael Valencic, Natrona Heights, PA (US); David Valencic, Natrona Heights, PA (US)

Correspondence Address: Michael Valencic, 212 Altermoor Drive, Natrona Heights, PA, 15065, US

(21) Appl. No.: 10/368,250

(22) Filed: Feb. 18, 2003

(51) Int. Cl. B26B 11/00

(52) U.S. Cl. 7/158

(57) ABSTRACT

A multi-function utility and survival tool, which incorporates a whistle, flint rock fire starter, an alumina—rod blade sharpening device, a honing stone, a glass shattering device, and a light reflecting signal device. All individual elements of this tool are combined into a single unit making it practical and convenient to use.

### BACKGROUND OF THE INVENTION

1. Field of Endeavor:

This invention relates to the sporting goods industry, and more specifically to a multi-function survival tool. A single unit comprising of a whistle, fire starter, blade sharpener, hook sharpener, signal mirror, and a glass-shattering device.

Currently, these items can be found in the market place as individual items. Although each of these items provides a useful purpose, alone they do not cover the many needs one may encounter in a survival situation. On a practical level, it would be too cumbersome to carry all of these items individually. By combining the above mentioned items into one multi-function tool, a convenient, practical tool can be utilized in the home, car, and virtually any outdoor activity. It can be used not only as a handy tool for everyday use, but also as a life saving device in a survival situation.

### BRIEF SUMMARY OF THE INVENTION

A multi-function general purpose utility and survival tool, which includes a three-chamber whistle, a flint rock fire starter, an alumina-rod style blade sharpener, an alumina honing stone, a hardened glass shattering device, and a signal mirror made of high-polished stainless steel.

A principle object and advantage of this device is a convenient and practical tool, which provides multiple functions as an aid to many sporting activities.

Another object and advantage of this device is the practical advantage of having several potential life saving features combined into a single unit, a necessity in a survival situation.

Other objects and advantages of this device will become readily apparent upon review of the following figures, specifications, and appended claims.

### BRIEF DESCRIPTION OF THE SEVERAL VIEWS OF THE DRAWING

FIG. 1 is a perspective view of the six in one multiple function survival tool. Each separate function of the tool is shown except the light reflecting signal device which is located on the back of the unit

FIG. 2 is a perspective view showing the light reflecting signal device, the back of the tool where the light reflecting signal device will be mounted, the whistle air chambers, and the whistle air compressor device.

### DETAILED DESCRIPTION OF THE INVENTION

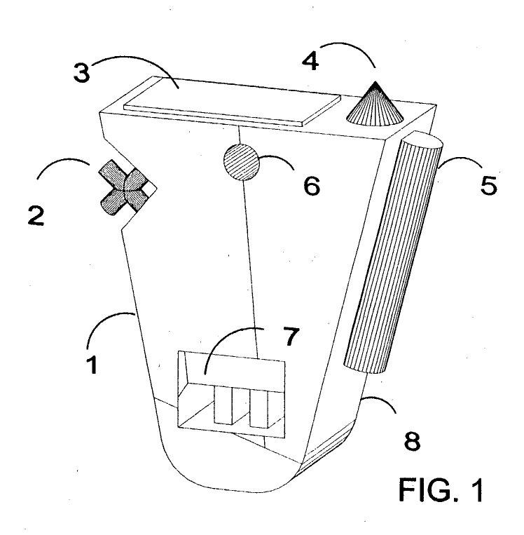

Referring to FIG. 1, this multiple function survival tool 1, were each function works independently from each other, is triangular in shape measuring two and one half inches high, two inches wide at the top of the triangle, one inch wide at the whistle opening part of the triangle, the body of the survival tool is one half of an inch deep.

Located in the upper left quadrant as viewed from the front FIG. 1, is the edge-sharpening tool 2. The sharpening stones are three quarter inches long by one eighth cylinder shaped Alumina Rod embedded into the body of the tool. The sharpening stones form a cutting angle of twenty-two degrees per side. The object being sharpened can be pulled through the “V” shape of the stones or the item being sharpened can be secured in its position and the “V” shaped sharpening stones dragged over the edge of the item being sharpened. The sharpening stones can be rotated or replaced as they become worn.

The two-inch wide top portion of the triangle has an embedded flat sharpening stone 3 and a hardened point 4. The Alumina rectangle sharpening stone 3 is glued into a recessed section of the survival tool. The stone 3 measures one inch long, one half of an inch wide, one eighth of an inch deep. This flat sharpening stone can be used for multiple purpose sharpening. Fishing hooks and edges of a cutting design can be sharpened on this stone. The hardened point 4 located adjacent to stone 3, to be used in an emergency situation where an escape route may be impeded by window glass. The body of the survival tool is grasped in either hand with the hardened point 4 facing away from the little finger. A firm fast hard strike of the point impacting on the surface of the glass will cause the glass to break providing the trapped individual an escape route to safety. The hardened point 4 base diameter will not exceed the depth of the survival tool, one half of an inch, and will not exceed three quarters of an inch high. Hardened point 4, is attached to the body of the survival tool via embedded threaded insert.

Flint rock 5 is a two inch by five sixteenth cylinder located on the right side of the survival tool as viewed in FIG. 1. Flint rock 5 is attached by glue into a concave cylinder shaped groove on the side of the survival tool 1. Scraping the flint rock 5 with a corner edge made of steel will cause the flint to spark enabling the user to start a fire. Upon gathering dried grass and leaves, point 4 is to be placed into the center of the material to be ignited. Point 4 aligns the flint rock 5 with the combustible material. While holding the tool firmly in hand the flint rock is scrapped with the edge of a steel object causing the flint to spark igniting the material to start a fire.

Hole 6 measures three sixteenth in diameter and is centered one quarter of an inch below the top section of the survival tool. Hole 6 allows the use of a lanyard for securing accessories to the survival tool. The whistle 7 is incorporated into the body of the survival tool. Whistle 7 consists of three air chambers.

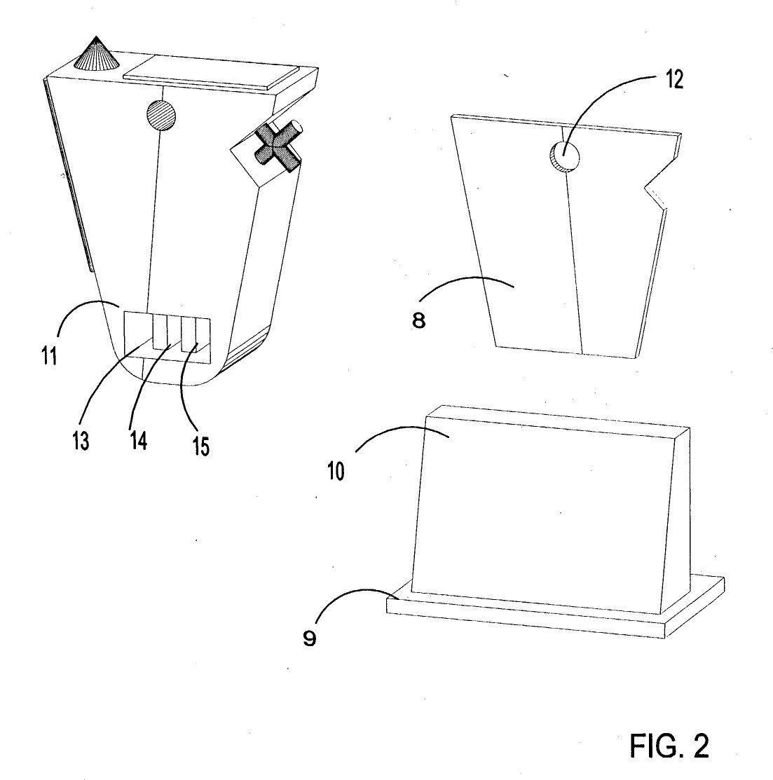

Referring to FIG. 2—air chambers 13, 14, 15 all have equal diameters of five sixteenth on an inch. Air chambers 13, 14, 15 vary in length and no two chambers will be of equal length. The middle air chamber 14 will remain the shortest, measuring one and one half inches in length. Air chamber 13, left side of middle as viewed in FIG. 2, is the second longest, measuring one and three quarter inches in length. Air chamber 15, right side of middle as viewed in FIG. 2, is longest, measuring two inches in length. These air chambers 13, 14, 15 resemble the pipes of a musical organ each generating a different tone. As the whistle is being used three different tones are being generated, independently of each other, merge together to form a unique oscillating harmony.

Again referring to FIG. 2 a high polished stainless steel light reflecting signal device 8, is attached to the back of the survival tool. The light reflecting signal device 8, has a hole 12 that overlays hole 6, FIG. 1 on the survival tool 1, and corresponds with the basic shape of the survival tool.

The whistle air compressor 9 is glued into a recessed hole 11 located on the backside of the whistle. The wedge 10 of whistle air compressor 9 forces the incoming air into the whistle air chambers 13, 14, 15, FIG. 2 with increased velocities and pressure to create the whistle tone. Wedge 10 measures one and one sixteenth long, has a height of one quarter of an inch, depth is one eighth of an inch at the base and one sixteenth of an inch at the top. Wedge 10 is manufactured off center of base eliminating improper installation of the part into the body of the survival tool during assembly.

The body of survival tool FIG. 1, the air compressor 9, FIG. 2 are made of high impact plastic.

What we claim as our invention is:

1. A multi-function general purpose utility and survival tool comprising:
(a) a three chambered whistle
(b) a flint rock fire starter
(c) a glass shattering device
(d) alumina rod blade sharpener
(e) alumina honing stone
(f) a light reflecting signal device

2. The whistle of claim 1(a), wherein the chambers vary in length to create three different tones blending into a unique oscillating harmony.

3. The whistle of claim 2, wherein the whistle air compressor is wedge shaped to force air into the chambers.

4. The flint rock fire starter of claim 1(b), being such an element that generates a hot spark sufficient to cause a flame when scraped with a knife-edge or other hard object.

5. The glass-shattering device of claim 1(c), consisting of a conical shaped hardened metal tip that is threaded into an insert within the body of the tool, is used to break or shatter glass by striking the tip against and perpendicular to the object.

6. The alumina blade sharpening rods of claim 1 (d), being molded into the body of the tool, form a V-shape to create a cutting angle of 22 degrees per side.

7. The blade sharpening rods of claim 6, wherein the rods are positioned in the body of the tool to provide safety to the user while sharpening a knife or other cutting edge.

8. The honing stone of claim 1 (e), wherein the honing stone is imbedded into the body of the tool to provide ease in sharpening fishing hooks or other pointed or odd shaped objects.

9. The sharpening elements of claim 1(d) and (e), wherein the material used can be made of alumina, carbide, diamond, or any other material capable of sharpening intended object.

10. The light reflecting signal device of claim 1(f), wherein a high polished stainless-steel surface, or any other reflective material is attached to the body of the tool to reflect light and direct it to a specific location as to signal or attract attention.

11. The light reflecting signal device of claim 9, wherein the hole in the reflecting surface overlays the hole in the body of the tool and is used as a peep sight to direct the reflected light toward the desired object.

12. The individual tools and features of claim 1(a,b,c,d,e,f), wherein all individual elements are combined to form a single multi-purpose tool.

13. The multi-purpose tool of claim 11, wherein the combination of elements or features into a single unit provides convenience and practicality for sporting or survival situations.

14. The multi-purpose tool of claim 12, wherein the body of said tool can be made of plastic, metal, or any material suitable for housing the individual elements into a single unit.
